(19) United States
(12) Patent Application Publication
(10) Pub. No.: US 2024/0370940 A1
(43) Pub. Date: Nov. 7, 2024

(54) SYSTEMS AND METHODS FOR EXPENSE ANALYSIS BASED GRAPHICAL USER INTERFACE ALERTS

(71) Applicant: Wells Fargo Bank, N.A., San Francisco, CA (US)

(72) Inventors: Christine Hill, San Francisco, CA (US); Indira Korrapati, San Francisco, CA (US); Jeff Klein, San Francisco, CA (US); Sean Newcomb, San Francisco, CA (US); Sarada Vempati, San Francisco, CA (US)

(73) Assignee: Wells Fargo Bank, N.A., San Francisco, CA (US)

(21) Appl. No.: 18/142,530

(22) Filed: May 2, 2023

(51) Int. Cl. G06Q 40/12; G06Q 20/40; G06Q 30/0601; G06Q 50/14; G06V 30/19; G06V 30/418

(52) U.S. Cl. CPC G06Q 40/12; G06Q 20/405; G06Q 30/0631; G06Q 50/14; G06V 30/191; G06V 30/418

(57) ABSTRACT

A computing system of a provider includes a network interface, a database that can store expense information of the provider, and one or more processors and a memory structured to store instructions that are executable to cause the one or more processors to receive a request to submit an invoice for an expense reimbursement, query a camera device of a first user device to scan the invoice, receive image data of the invoice based on the scan, extract a plurality of data elements of the image data of the invoice, compare the plurality of data elements with the stored expense information of the provider, determine that at least one data element of the plurality of data elements meets an alert criteria, store the plurality of data elements of the invoice in the database, and transmit, to a second user device, a notification including an indication to review the invoice.

### BACKGROUND

Various travel expenses may be incurred when planning and attending a trip. Typically, such expenses are managed and tracked manually by the traveler during or after the completion of the trip. In some instances, such manual tracking may cause the traveler to exceed a spending limit or lose track of certain expenses. Expense reimbursements for such trips can also be a source of fraud.

### SUMMARY

At least one aspect of this disclosure is directed to a computing system of a provider. The computing system includes a network interface, a database configured to store expense information of the provider, and a processing circuit comprising a processor and a memory, in which the memory is structured to store instructions that are executable to cause the processor to: receive, via the network interface and via a manual input to a first user device communicably coupled to the computing system, a request to submit an invoice for an expense reimbursement, query, via the network interface, responsive to receiving the request, a camera device of the first user device to scan the invoice, receive, via the network interface and via the first user device, image data of the invoice based on the scan, extract, via a content recognition algorithm, a plurality of data elements of the image data of the invoice, compare the plurality of data elements with the stored expense information of the provider, determine, based on the comparison, that at least one data element of the plurality of data elements meets an alert criteria, store the plurality of data elements of the invoice in the database with an indication to prevent an initiation of funds corresponding to the expense reimbursement responsive to determining the at least one data element meets the alert criteria, and transmit, via the network interface, to a second user device communicably coupled to the computing system, a notification including an indication to review the invoice.

At least one aspect of this disclosure is directed to a computing system of a provider. The computing system includes a network interface, a database configured to store transaction information of the provider, and a processing circuit comprising a processor and a memory, in which the memory is structured to store instructions that are executable to cause the processor to: receive, via the network interface, transaction data associated with an account of the plurality of accounts for a predetermined time period, compare the transaction data with the stored transaction information of the provider, determine, based on the comparison, a remaining spending limit of the account for the predetermined time period, generate a graphical user interface (GUI) that includes a graphical representation corresponding to the remaining spending limit, and provide, via the network interface, to a user device associated with the account, the GUI.

At least one aspect of this disclosure is directed to a computing system of a provider. The computing system includes a network interface, a database configured to store travel information of the provider, and a processing circuit comprising a processor and a memory, in which the memory is structured to store instructions that are executable to cause the processor to: request, via an application programming interface (API) of a third-party computing system and via the network interface, travel data for a predetermined date and location, receive, via the API of the third-party computing system and via the network interface, the travel data, compare the travel data with the stored travel information of the provider, determine, based on the comparison, that at least one travel data element of the travel data meets an alert criteria, and transmit, via the network interface, to a user device communicably coupled to the computing system responsive to determining the at least one travel data element meets the alert criteria, a recommendation corresponding to at least one of an alternative travel consideration, a budget, or a spending limit.

This summary is illustrative only and is not intended to be in any way limiting. Other aspects, inventive features, and advantages of the systems or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the disclosure may be combined with one or more features of a different aspect of the disclosure. Moreover, additional features may be recognized in certain embodiments and/or implementations that may not be present in all embodiments or implementations.

### BRIEF DESCRIPTION OF THE DRAWINGS

FIG. 1 is a block diagram of a system for planning, processing, and managing expenses, according to an example embodiment.

FIG. 2 depicts a flowchart showing an example method of planning and managing travel accommodations and expenses, according to an example embodiment.

FIG. 3 depicts a flowchart showing an example method of managing expenses, according to an example embodiment.

FIG. 4 depicts a flowchart showing an example method of managing expenses in real-time, according to an example embodiment.

FIG. 5A depicts an exemplary user interface for managing and planning travel accommodations, according to an example embodiment.

FIG. 5B depicts an exemplary user interface for managing and planning travel accommodations, according to an example embodiment.

FIG. 6A depicts an exemplary user interface for submitting invoices, according to an example embodiment.

FIG. 6B depicts an exemplary user interface for managing invoices, according to an example embodiment.

FIG. 7A depicts an exemplary user interface for managing a user account, according to an example embodiment.

FIG. 7B depicts an exemplary user interface for managing transactions of a user account, according to an example embodiment.

FIGS. 7C and 7D depict exemplary user interfaces for managing transactions of a user account, according to an example embodiment.

### DETAILED DESCRIPTION

Various embodiments discussed herein relate to systems and methods for providing customers an automated way of planning a trip, estimating expenses, and managing expenses before, during, or after the trip. Specifically, the various embodiments discussed herein allow customers to input parameters to determine optimized travel options and/or an estimated total budget, submit and manage expenses automatically, and track transactions related to traveling in real-time in relation to a predetermined budget.

According to the embodiments described herein, the systems and methods described herein automate the process of planning for a trip and managing estimated expenses by receiving a plurality of parameters that define a trip (e.g., location, dates, number of attendees, etc.). The systems and methods described herein request travel data from one or more third party entities based on the defined travel parameters via a third party application programming interface (API) (e.g., by transmitting an API call). The systems and methods described herein receive the requested travel data and compare the data with stored information of a provider to determine if an alert criteria has been met (e.g., if prices, availability, weather, event data, or other data meets or exceeds a threshold). The systems and methods described herein transmit a recommendation corresponding to one or more of a travel consideration, a budget, a spending limit, or other information related to planning the trip responsive to determining the alert criteria is met.

According to the embodiments described herein, the systems and methods described herein automate the process of managing expense reports by receiving a request from a first user to submit an expense, transmitting a prompt to the first user to provide invoice data, and receiving the invoice data (e.g., an amount, a name, a vendor, a location, a date, etc.). The systems and methods described herein extract a plurality of data elements of the invoice data and compare the data elements with stored expense information of a provider (e.g., with authorized users, authorized payment amounts, known vendor information, etc.). The systems and methods described herein determine if an alert criteria has been met based on the comparison, and transmit a notification including an indication to review the invoice to a second user prior to processing the expense report for reimbursement.

According to the embodiments described herein, the systems and methods described herein automate the process of managing real-time transactions by receiving transaction data associated with an account of a user for a specified amount of time (e.g., a certain day). The systems and methods described herein compare the received transaction data with stored transaction information of a provider (e.g., a spending limit or predetermined budget) to determine a remaining spending limit. The systems and methods described herein generate and provide a graphical user interface that includes a representation of the remaining spending limit to a user device.

The systems and methods described herein provide various improvements over existing technology and current solutions. For example, the systems and methods described herein significantly increase efficiency and effectiveness of planning and managing a trip and expenses associated with a trip. Typically, when planning a trip, a customer manually checks pricing and availability of travel expenditures through one or more third party entities. By automating a process using API calls, web scraping, and/or machine learning algorithms, the systems and methods described herein significantly increase efficiency and reduce the risk of unnecessary expenses of planning travel accommodations (e.g., by using continuous data pulling and/or historical patterns to automatically detect alternative travel recommendations). Additionally, a customer typically manually opens, reviews, and approves expenses when managing expense reports. By automating an expense management process using one or more machine learning algorithms and/or by continuously pulling, aggregating, and cross-referencing expense data with received user expense information, the systems and methods described herein reduce a click path of a customer as the customer does not need to manually open each received invoice for review. Further, by tracking real-time transactions of a user (e.g., while on a trip with a predetermined budget), the systems and methods described herein can facilitate reducing fraudulent activity, maintaining a set budget, and providing remedies to adjust user's behavior in real-time (e.g., suggesting to user a first method of payment over a second), thereby increasing security of a user's account. Various additional advantages are described herein.

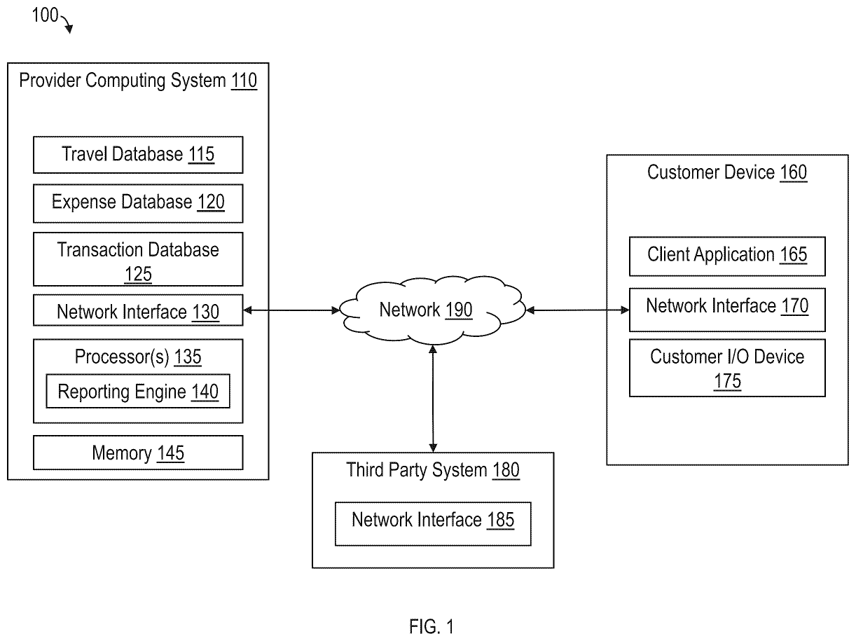

Referring now to FIG. 1, an embodiment of an environment 100 is depicted. As shown, the environment 100 includes one or more provider computing systems 110 associated with a provider, one or more customer devices 160, and one or more third party systems 180. The provider computing system(s) 110, the customer device(s) 160, and the third party system(s) 180 are in communication with each other and are connected by a network 190, which may include one or more of the Internet, cellular network, Wi-Fi, Wi-Max, a proprietary banking network, or any other type of wired or wireless network or a combination of wired and wireless networks. As described herein, the environment 100 may be used to manage, track, and process transactions, expenses, and other accommodations related to travel.

For clarity, the following description may refer to a provider computing system 110, a customer device 160, and an third party system 180. However, it will be understood that the following description of any of these devices and computing systems will be similarly applicable to any additional corresponding devices and computing systems (e.g., additional provider computing systems 110, customer devices 160, third party systems 180) and that, in some embodiments, the environment 100 may include a plurality of any of the described devices and systems.

The provider computing system 110 is owned by, associated with, or otherwise operated by a provider institution that maintains one or more accounts held by various customers (e.g., a customer associated with the customer device 160), such as demand deposit accounts, credit card accounts, receivables accounts, and so on. In some implantations, the provider may be a provider of financial services, such as financial institution or a bank. In some instances, the provider computing system 110, for example, may include one or more servers, each with one or more processing circuits having one or more processors 135 configured to execute instructions stored in one or more memory devices to send and receive data stored in the one or more memory devices and perform other operations to implement the methods described herein associated with logic or processes shown in the figures. In some instances, the provider computing system 110 may be or may include various other devices communicably coupled thereto, such as, for example, desktop or laptop computers (e.g., tablet computers), smartphones, wearable devices (e.g., smartwatches), and/or other suitable devices.

In some embodiments, the provider computing system 110 includes a travel database 115, an expense database 120, a transaction database 125, a network interface 130, a processor 135 and reporting engine 140, and a memory 145. In some instances, the network interface 130 includes, for example, program logic that connects the provider computing system 110 to the network 190. The network interface 130 facilitates secure communications between the provider computing system 110, the customer device(s) 160 and/or the third party system(s) 180. The network interface 130 also facilitates communication with other entities, such as other banks, settlement systems, and so on.

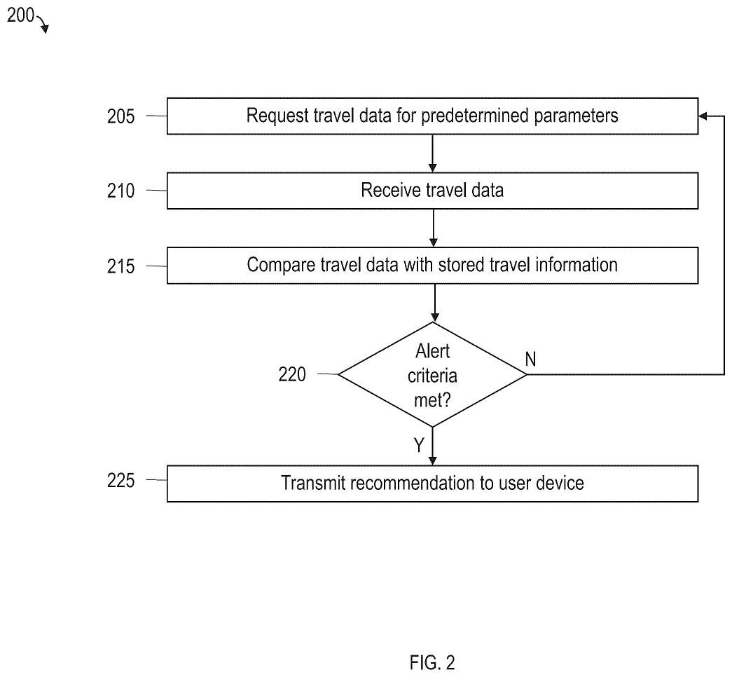

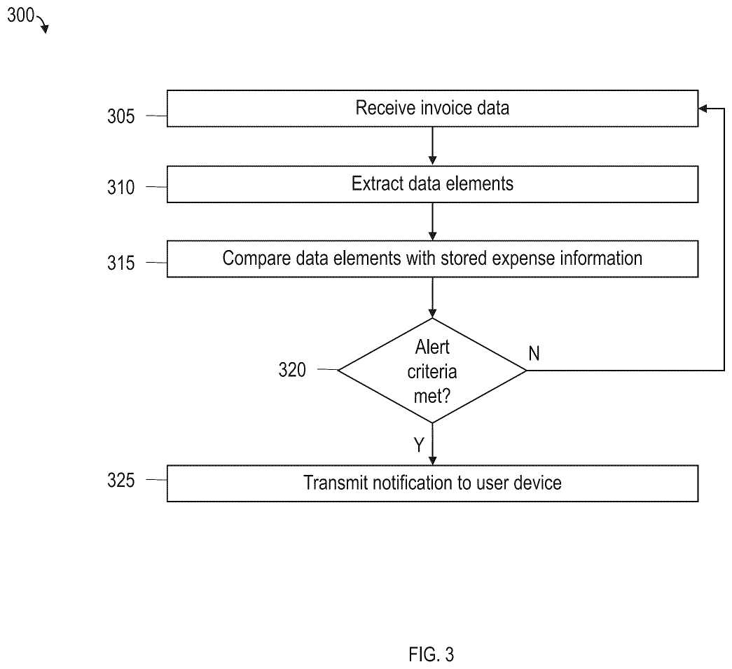

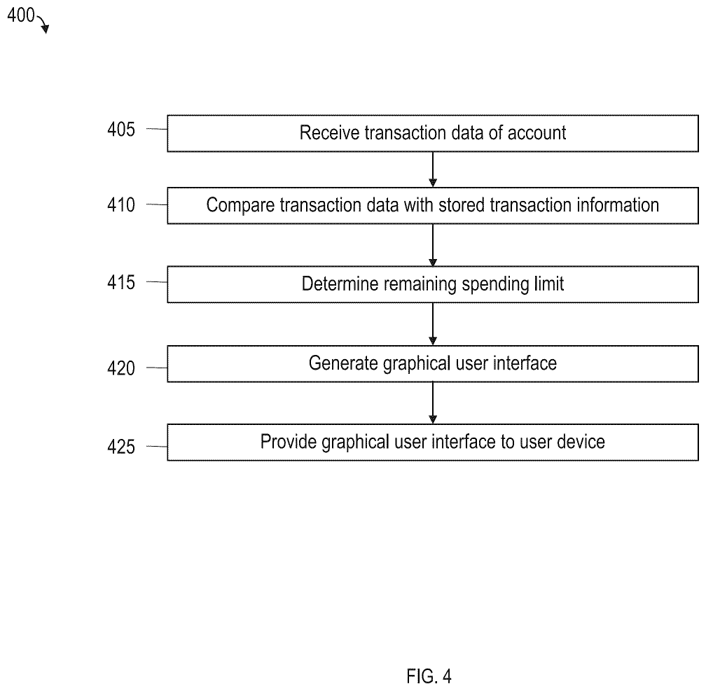

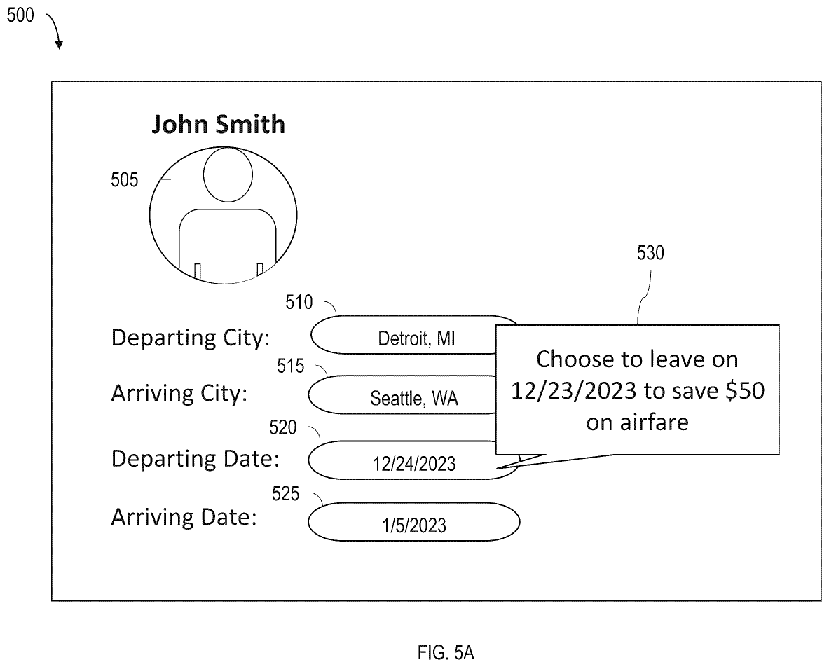

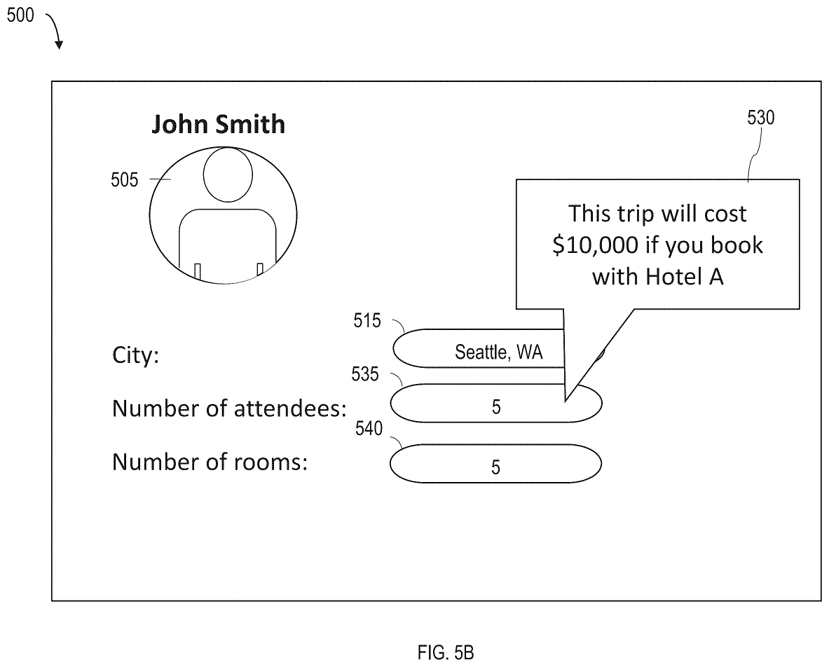

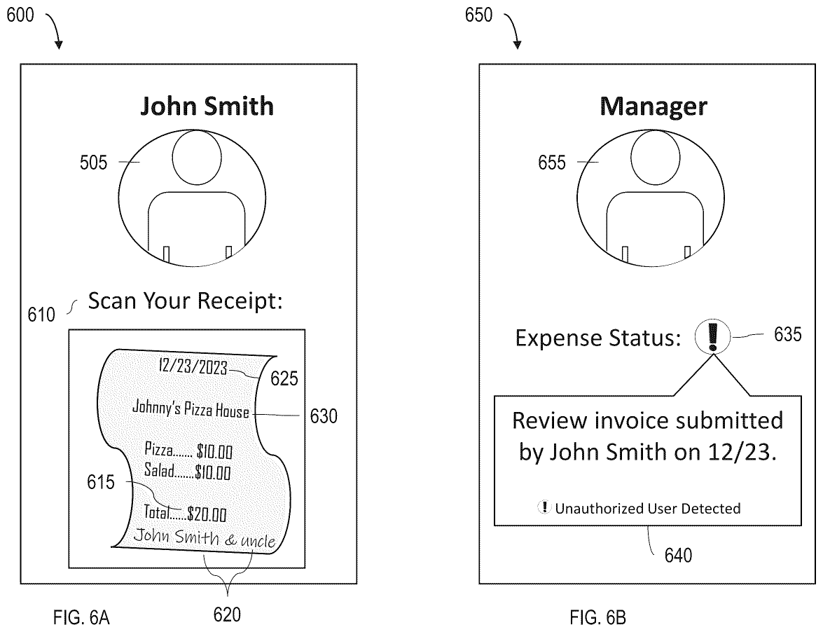

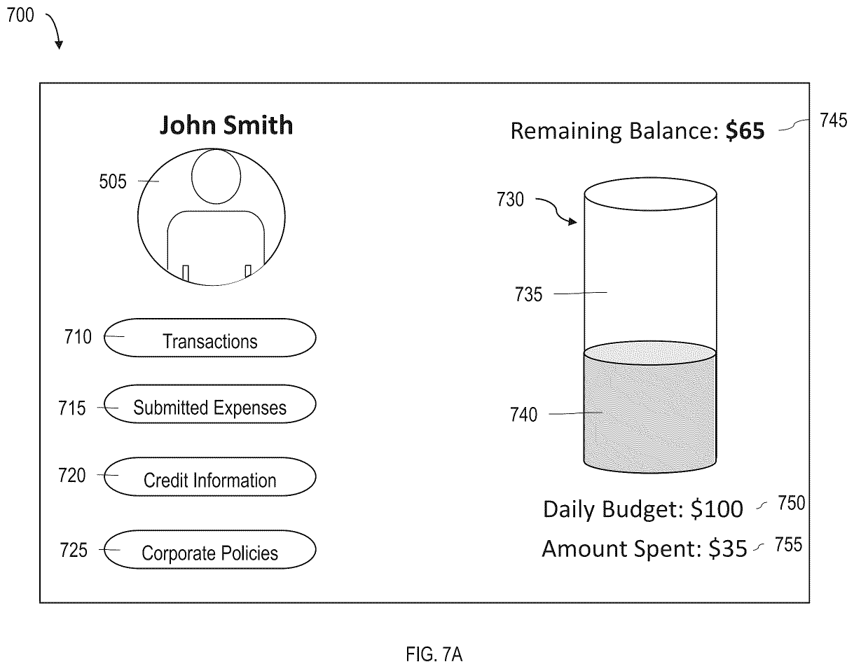

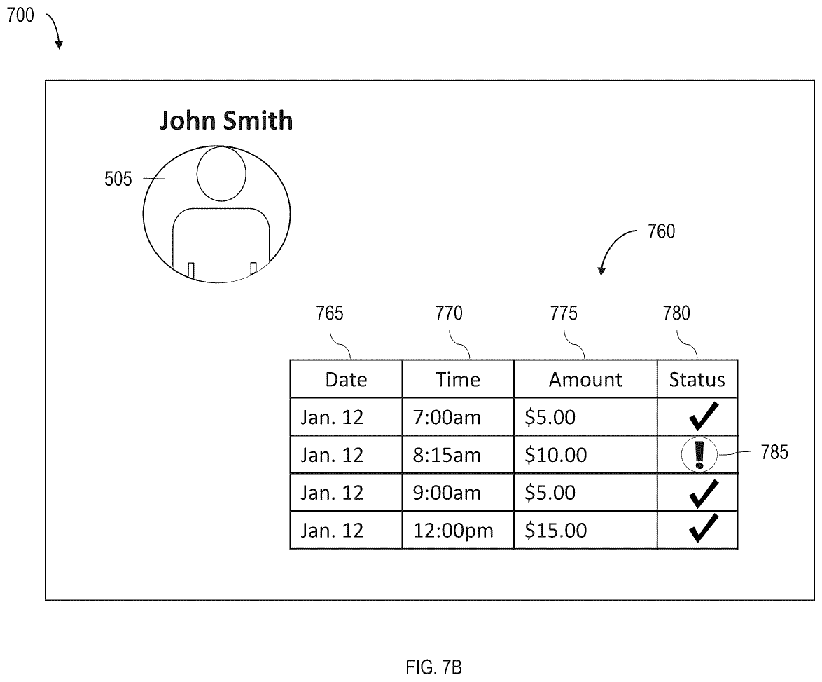

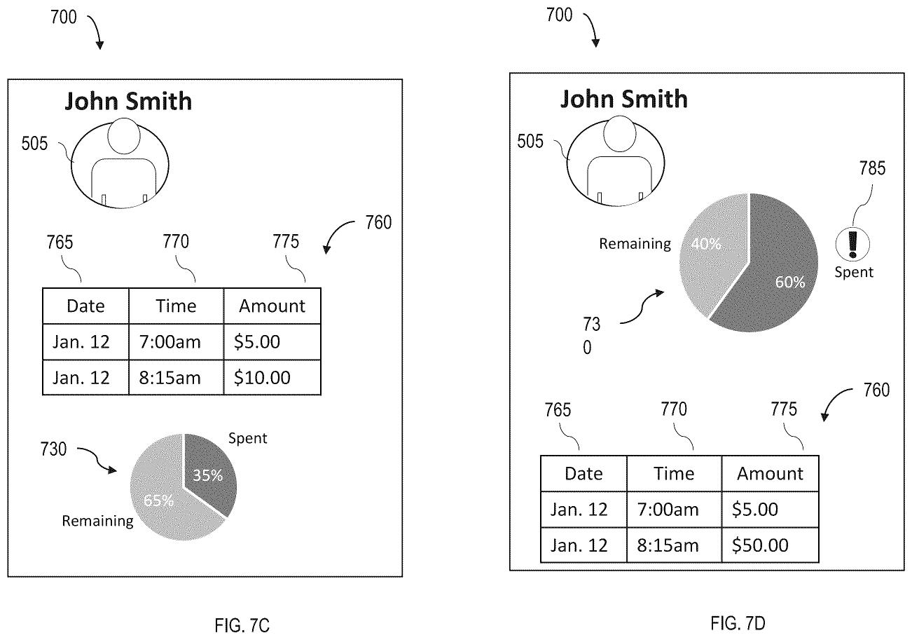

The reporting engine 140 is structured or configured to perform a variety of functionalities or operations to enable and monitor various customer activities (e.g., expense processing, transaction processing, etc.) in connection with travel information, expense information, and transaction information stored within the travel database 115, the expense database 120, and the transaction database 125. The reporting engine 140 may be structured or configured to perform various functionalities to enable recommended travel accommodations for a customer of the customer device 160, including alternative travel recommendations, recommended budgets, and determined foreign exchange activity, as described with reference to FIGS. 2 and 5A-5B. The reporting engine 140 may be structured or configured to perform various functionalities to enable flagging potentially fraudulent expenses to the customer device 160, as described with reference to FIGS. 3 and 6A-6B. The reporting engine 140 may be structured or configured to perform various functionalities to enable providing a user interface to the customer device 160 that allows a customer to track daily expenses while traveling, as described with reference to FIGS. 4 and 7A-7D.

In some instances, the reporting engine 140 is configured to, for each customer activity performed, automatically or nearly automatically pull travel information, expense information, and transaction information (e.g., from the travel database 115, expense database 120, and/or transaction database 125) pertaining to the provider, the customer, and/or the customer account associated with the customer activity and to process the travel information, expense information, and/or transaction information to provide the information to a customer on the customer device 160, as described herein. The reporting engine 140 further includes user interface program logic configured to generate and present web pages to users accessing the provider computing system 110 over the network 190.

In some instances, the travel information includes, but is not limited to, historical and/or average data regarding travel expenses including lodging prices or availability, transportation prices or availability, price caps or thresholds, and/or cost of food or other expenses. The travel information may additionally or alternatively include historical or current weather data and/or event data associated with a location and/or date. In some instances, the expense information includes, but is not limited to, stored names of authorized or historical users, locations, corporate expense policies (e.g., rules, thresholds, etc.), and/or payment amounts and methods. In some instances, the transaction information includes, but is not limited to, previous and potential upcoming customer transactions, means of making payments, and/or spending limits.

As will be described further herein, the travel database 115, expense database 120, and/or transaction database 125 are configured to be used by the reporting engine 140 to identify various travel and/or expense data, compare the data with information stored in the one or more databases, and provide a customer of the customer device 160 access to manage various travel and/or expense activities based on the comparison.

The customer device 160 is owned, operated, controlled, managed, and/or otherwise associated with a customer (e.g., a customer holding an account of the provider). In some embodiments, the customer device 160 may be or may include, for example, a desktop or laptop computer (e.g. a tablet computer), a smartphone, a wearable device (e.g., a smartwatch), a personal digital assistant, and/or any other suitable computing device. In the example shown, the customer device 160 is structured as a mobile computing device, namely a smartphone.

In some embodiments, the customer device 160 includes one or more I/O devices 175, a network interface 170, and one or more customer client applications 165. While the term “I/O” is used, it should be understood that the I/O devices 175 may be input-only devices, output-only devices, and/or a combination of input and output devices. In some instances, the I/O devices 175 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 175 further include one or more user interfaces (devices or components that interface with the customer), which may include one or more biometric sensors (such as a fingerprint reader, a heart monitor that detects cardiovascular signals, face scanner, an iris scanner, etc.).

The network interface 170 of the customer device 160 includes, for example, program logic and various devices (e.g., transceivers, etc.) that connect the customer device 160 to the network 190. The network interface 170 facilitates secure communications between the customer device 160 and each of the provider computing system 110 and the third party system 180. The network interface 170 also facilitates communication with other entities, such as other banks, settlement systems, and so on.

The customer device 160 stores in computer memory, and executes (“runs”) using one or more processors, various customer client applications 165, such as an Internet browser presenting websites, text messaging applications (e.g., for sending MMS or SMS to the provider computing system 110, and/or applications provided or authorized by entities implementing or administering any of the computing systems in environment 100).

For example, in some instances, the client applications 165 include a customer provider institution client application (e.g., a provider banking application) provided by and at least partly supported by the provider computing system 110. For example, in some instances, the client application 165 coupled to the provider computing system 110 may enable the customer to perform various customer activities (e.g., account or expense management, tracking, etc.) and/or perform various transactions associated with one or more customer accounts of the customer held at the provider associated with the provider computing system 110 (e.g., account opening and closing operations, fund transfers, etc.).

In some instances, the client application 165 provided by the provider computing system 110 may additionally be coupled to the third party system 180 (e.g., via one or more APIs and/or software development kits (SDKs)) to integrate one or more features or services provided by the third party system 180.

The third party system 180 includes a respective network interface 185 to facilitate exchanging data with the provider computing system 110 and/or the customer device 160 through the network 190. The third party system 180 may be associated with a third party entity. For example, the third party entity may be or may include various traveling and/or expense management organizations and websites (e.g., KAYAK®, Expedia Group, Tripadvisor, trivago, Google Flights, Yelp, Concur®, Hotels.com, Booking.com, The Weather Channel, airline websites, etc.). The third party system 180 may include one or more APIs and/or servers associated with the third party entity for exchanging data with the provider computing system 110 and/or the customer device 160, as described herein.

With an example structure of the environment 100 being described above, example processes performable by the environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring to FIG. 2, a flow diagram of a method 200 for managing and planning travel accommodations is shown, according to an example embodiment. Various operations of the method 200 may be conducted by the environment 100 and particularly parts thereof (e.g., the provider computing system 110, the customer device 160, and the third party system 180).

As shown, the method 200 begins by the reporting engine 140 requesting travel data for a predetermined date, location, and/or other parameters at step 205. In some implementations, the reporting engine 140 may request travel data responsive to receiving a plurality of inputs. For example, the reporting engine 140 may receive one or more inputs through a user interface (e.g., user interface 500 depicted in FIGS. 5A and 5B) of the customer device 160. The plurality of inputs (e.g., via an entry to a touch screen, a selection of a selectable feature using a cursor, etc.) may include at least one travel parameter. For example, the travel parameter may define one or more bounds and/or limitations for requesting the travel data. In some implementations, the reporting engine 140 may receive one or more dates, locations, times, number of people, and/or other parameters that define requesting the travel data (e.g., define trip information). Referring briefly to FIGS. 5A and 5B, depicted is an example user interface 500 displayed to the customer device 160 for inputting travel parameters. The user interface 500 may be specific to a user profile 505 of the user of the customer device 160 (e.g., a user level profile that corresponds to an account of the provider stored in an account database of the provider computing system 110). The user interface 500 can include at least one selectable feature including, but not limited to, a departing location input 510, an arriving location input 515, a departing date input 520, an arriving date input 525, a number of attendees input 535, and/or a number of rooms input 540. The user interface 500 can additionally or alternatively include one or more inputs for a specific time, method of transportation, (e.g., train, airline, car, etc.), method of lodging (e.g., hotel, motel, etc.), currency type (e.g., US dollar, pound, Euro, etc.), and/or various other travel parameters. In some implementations, the parameters may include one or more personal preferences of a user (e.g., allergies, location preferences, etc.)

Referring back to FIG. 2, responsive to receiving the one or more inputs corresponding to travel parameters, the reporting engine 140 may request travel data defined by the one or more travel parameters. In some implementations, the reporting engine 140 may request travel data from one or more travel organizations and/or sites. For example, the reporting engine 140 may establish a link between the provider computing system 110 and a third party API of the third party system 180 to request information via the third party API. For example, the reporting engine 140 may query a server of the provider computing system 110 to transmit an API call to a server of the third party system 180 requesting travel data defined by the received travel parameters. The server of the provider computing system 110 may receive the travel data via an API of the third party system 180 responsive to the API call. In some implementations, the travel data may include publically available information. For example, the reporting engine 140 may query an API call to an exposed API of the third party system 180. In some implementations, the reporting engine 140 may use web scraping algorithms and image recognition logic to pull and aggregate data of the third party system additionally or alternatively with the API call. As described herein, the third party entity associated with the third party system 180 may include various travel and/or expense websites including, but not limited to, KAYAK.com, expedia.com, Tripadvisor.com, trivago.com, Google Flights, Concur.com, Yelp.com, Hotels.com, Booking.com, weather.com, airline websites (e.g., Delta.com), etc.

The requested travel data may be defined by the specified date, time, and/or location. For example, the API call may include one or more data packets, identifiers, or other indications that specify the travel parameters received by the user interface 500 including a predetermined date (e.g., from December 24 through January 5, etc.), a predetermined time (e.g., 7:00 am to 5:00 pm, etc.), a predetermined location (e.g., Seattle, Detroit, New York, etc.), a predetermined number of attendees (e.g., five), and/or other specified parameters. The reporting engine 140 may request for various information of the predetermined date, time, and/or location. For example, the reporting engine 140 may request for a number of flights between various airports and/or prices of flights, rental cars, trains, hotels and/or other lodging within a predefined location (e.g., within 50 miles of a city, etc.), average and/or predicted weather data, event data (e.g., known concerts, conventions, or other events within a predetermined distance of the location), and/or current or historical expense data (e.g., average cost of fuel, food, and other expenses within the area).

In some implementations, the reporting engine 140 may query requests for information from multiple third party entities via one or more third party APIs. For example, the reporting engine 140 may request first data from a first third party entity (e.g., flight prices from Delta.com) by querying a first API call, second data from a second third party entity (e.g., hotel prices and/or availability from hotels.com) by querying a second API call, third data from a third party entity (e.g., weather data from weather.com) by querying a fourth API call, and/or fourth data from a fourth third party entity (e.g., average cost of fuel from gasprices.aaa.com) by querying a fifth API call. In some implementations, the reporting engine 140 may request information (e.g., one or more travel data) from one third party entity via the third party API. For example, the reporting engine 140 may request first and/or second data from a first third party entity (e.g., flight and hotel information from Booking.com) by querying an API call.

The reporting engine 140 receives the requested travel data at step 210. For example, the reporting engine 140 may receive the requested travel data responsive to the API call via the third party API to the third party system 180. The reporting engine 140 may additionally or alternatively receive the requested travel data responsive to web scraping. As described herein, the reporting engine 140 may receive the data from multiple third party entities and/or from one single third party entity. In some implementations, the reporting engine 140 may receive the one or more travel data as a data packet via the third party API and/or via web scraping.

The reporting engine 140 compares the received travel data with stored travel information at step 215. In some implementations, the reporting engine 140 may pull data automatically from the travel database 115 responsive to receiving the travel parameters from the customer device 160 and/or travel data from the third party entity. In some implementations, the reporting engine 140 may pull data responsive to receiving a request (e.g., a user input to the user interface 500 of the customer device 160) to compare the travel data with stored travel information. For example, the user interface 500 may include an input (e.g., button) for a user to request the system to compare travel data for the specified parameters with stored data. As described herein, the stored travel information within the travel database 115 can include, but is not limited to, specific rules (e.g., a price cap for hotels, flights, food, fuel, specific locations, etc.) and/or average prices and/or availability of lodging, transportation, food, fuel, etc. For example, the reporting engine may parse the data received via the third party API and extract particular travel data elements. The reporting engine 140 may compare the extracted travel data elements with the stored travel information. For example, the reporting engine 140 may compare an extracted price of transportation (e.g., flight, car, bus, train) with a predetermined price cap within the travel database 115 to determine if the price is greater than, equal to, or less than the price cap (or within a specified range or percentage). As another example, the reporting engine 140 may compare an average price of fuel, food, or other expenses with stored historical average prices to determine a difference. As yet another example, the reporting engine 140 may compare weather data and/or event data to a predetermined threshold to determine if the data meets or exceeds the threshold.

The reporting engine 140 may compare the received travel data with the stored travel information once, continuously, and/or cyclically. For example, the reporting engine 140 may compare the received travel data with one or more stored travel information in real-time after receiving the travel data. As another example, the reporting engine 140 may compare the received travel data with one or more stored travel information in cycles for a predetermined amount of time (e.g., twice every five minutes for three hours). As yet another example, the reporting engine 140 may compare the received travel data with one or more stored travel information continuously over a period of time. In other words, the reporting engine 140 may compare the travel data with the stored travel information within the travel database 115 and update the comparison responsive to information within the travel database 115 updating. By way of example, a predetermined price cap for a certain location may change over time. The reporting engine 140 may compare the received travel data with the predetermined price cap one or more times to dynamically update the difference between the travel data and stored data.

The reporting engine 140 may cyclically and/or continuously pull travel data from third party entities via the third party API over a period of time to dynamically compare the travel data and travel information. For example, the reporting engine 140 may request and/or receive travel data via the one or more API links (e.g., by transmitting multiple API calls to the same server) such that the reporting engine 140 receives dynamic updates if one or more of the travel data change over time (e.g., a price of a plane ticket drops or increases within a few minutes).

The reporting engine 140 determines if an alert criteria is met at step 220. The reporting engine 140 may determine if an alert criteria is met based on and/or in response to the comparison between the travel data and stored travel information. In some implementations, the reporting engine 140 may determine an alert criteria is met based on a price (e.g., price of transportation, lodging, fuel, food, etc.) meeting and/or exceeding a predetermined threshold. In some implementations, the reporting engine 140 may determine an alert criteria is met based on an amount of lodging (e.g., hotels, motels, house rentals, etc.) available within a period of time meeting or exceeding a threshold (e.g., a threshold being less than a certain amount of hotels have open rooms, a hotel has less than a certain amount of rooms available, etc.). In some implementations, the reporting engine 140 may determine an alert criteria is met based on weather data and/or event data meeting or exceeding a threshold (e.g., percentage of precipitation, temperature highs or lows, amount of concerts at a venue located within a predetermined distance of the location, etc.).

By way of example, the reporting engine 140 may receive a travel data element via the third party API indicating that three flights from Detroit to Seattle are available on a selected day/time at a price of $700 each. The reporting engine 140 may compare the data with stored information within the travel database 115 that indicates a price threshold for traveling to Seattle is set at $550. The reporting engine 140 may determine, based on the comparison, that the flights are above the price threshold and therefore an alert criteria is met. As another example, the reporting engine 140 may receive a travel data element from a third party API indicating that a winter storm watch was issued in a selected location. The reporting engine 140 may compare the travel data with stored weather information in the travel database 115 that indicates that a winter storm watch and/or warning exceeds a threshold for an alert criteria. As yet another example, the reporting engine 140 may receive travel data from a third party API indicating three hotel rooms are available in the selected location. The reporting engine 140 may compare the travel data with availability information in the travel database 115 that indicates that an availability threshold is less than five hotel rooms available. The reporting engine 140 may determine the travel data exceeds a threshold for an alert criteria responsive to the comparison.

In some implementations, the reporting engine 140 may determine an alert criteria is met responsive to receiving a user input to the user interface 500. For example, the user interface 500 may include a selectable feature that indicates a user of the user interface 500 requests a budget amount or other information based on the plurality of travel parameters prior to, during, or after the reporting engine 140 requests travel information. The reporting engine 140 may determine an alert criteria is met responsive to receiving an input to the selectable feature indicating a user request a budget amount. For example, in some implementations, the reporting engine 140 may determine an alert criteria is met even if no prices or other received data meet or exceed a threshold. In some implementations, the reporting engine 140 may determine an alert criteria is met responsive to determine an amount of attendees on the trip exceeds a predetermined threshold amount (e.g., more than 1).

The reporting engine 140 may include and/or may use one or more trained machine learning models (e.g., stored within the travel database 115). For example, the machine learning models may be trained using historical data stored within the travel database 115. The various machine learning models may include neural networks (e.g., convolutional neural networks, deep neural networks), Support Vector Machines (SVMs), Random Forests, or the like. The machine learning models may be trained on known input-output pairs given known inputs. For example, the machine learning models may be trained to predict when certain dates, times, locations, or other parameters may result in meeting an alert criteria even when various thresholds are not met (e.g., the machine learning models may be trained to determine that prices are higher than average during certain holidays, that certain locations have less availability during certain seasons, etc.). The machine learning models may additionally or alternatively be trained to predict when certain thresholds should be overridden due to other factors.

By way of example, the reporting engine 140 may receive a travel data element via the third party API indicating that a hotel room costs $150 a night in a selected city on December 24. The reporting engine 140 may compare the cost with stored information in the travel database 115 and determine that the cost does or does not exceed a threshold. The reporting engine 140 may use one or more machine learning models that determine that prices of transportation and food are typically higher during the end of December than normal. The reporting engine 140 may then determine that an alert criteria is met based on the machine learning models. As another example, the reporting engine 140 may compare a plurality of lodging travel data with one another and with the stored travel information. The reporting engine 140 may determine that a first lodging merchant offers a lower price than a second lodging merchant. The reporting engine 140 may determine, based on the comparison with stored travel information, that the first lodging merchant is below a threshold value and therefore does not meet an alert criteria. However, the reporting engine 140 may determine, based on the machine learning models, that a potential cost of transportation (e.g., rental car, taxicab, Uber, Lyft, etc.) to the first lodging merchant exceeds a savings amount of choosing the second lodging merchant. The reporting engine 140 may determine an alert criteria is met based on the machine learning models.

If the reporting engine 140 determines that no alert criteria has been met, the reporting engine returns to step 205 to continuously and/or cyclically pull or request travel data from one or more third party entities. For example, the reporting engine 140 may return to step 205 responsive to the reporting engine 140 determining that received price, availability, weather, event, and/or other parameters do not exceed a threshold.

If the reporting engine 140 determines an alert criteria has been met, the reporting engine 140 transmits a notification and/or recommendation 530, as depicted in FIGS. 5A and 5B, to the customer device 160 at step 225. In some implementations, the reporting engine 140 may transmit a recommendation 530 corresponding to an alternative travel consideration. For example, the reporting engine 140 may determine that a price and/or availability of transportation methods and/or lodging methods exceed a threshold for a selected date or location. The reporting engine 140 may request the third party system 180 for additional travel data based on a different date and/or location. For example, the reporting engine 140 may pull travel data for a window of time (e.g., a day, two days, etc.) before and/or after the previously selected window and/or for a location within a predetermined distance (e.g., 50 miles, 100 miles) of the previously selected location. The reporting engine 140 may compare the new received travel data with the previously received travel data that exceeded a threshold and/or with stored information within the travel database 115. The reporting engine 140 may determine, responsive to the comparison, that a different date, time, and/or location is closer to and/or below the threshold as compared to the previously selected date, time, and/or location. By way of example, the reporting engine 140 may determine that a price of a flight on a first day to a first airport in a first city exceeds a threshold amount. The reporting engine 140 may pull flight prices for the day before and/or day after the first day for the same first airport and/or for a second different airport located nearby the first airport. The reporting engine 140 may determine that a price of a flight on a second day for the second airport is within the threshold level. Responsive to the determination, the reporting engine 140 may transmit a notification to the customer device 160 indicating the flight for the second day to the second airport (e.g., through a user interface of the customer device 160). For example, the recommendation 530 may include text (e.g., “choose to leave on Dec. 23, 2023 to save $50 on airfare,” “this trip is not compliant with corporate policies,” etc.). These examples are for illustrative purposes. The recommendation 530 may include alternative methods of travel (e.g., a car or train as opposed to a flight), alternative rooms or types of hotels, alternative dates or time of travel, or other alternative travel recommendations. The recommendation 530 can include various additional or alternative texts, images, sounds, or other features.

In some implementations, the recommendation 530 may include a recommendation to limit the number of attendees to meet a budget and/or price threshold. For example, the reporting engine 140 may transmit a recommendation 530 indicating to travel more or less attendees to reach a budget amount based on a comparison between the received travel data and the stored travel information (e.g., responsive to determining the cheapest flights, hotels, etc. are above a threshold level).

In some implementations, the reporting engine 140 may transmit a recommendation 530 corresponding to determining a recommended budget. For example, the reporting engine 140 may determine an estimated amount of spending based on the received travel data. In some implementations, the reporting engine 140 may calculate a total amount of estimated expenses based on historical data, average prices of the location, and/or the amount of attendees. For example, the reporting engine 140 may automatically pull historical data corresponding to prices of flights and/or other means of transportation, prices of lodging, lodging availability, or other historical data stored within the travel database 115 before, during, after, or without the comparison. The reporting engine 140 may calculate, based on the pulled historical data, an estimated amount of spending over a period of time (e.g., price per day, per week, etc.). For example, the reporting engine 140 may calculate, based on an historical data for a specific location, an average amount of spending for the period of time. The reporting engine 140 may determine, based on the average amount of spending, a recommended budget. By way of example, the reporting engine 140 may determine an average daily amount spent by previous users at a specified location (e.g., based on average and/or historical spending habits for the location). The reporting engine 140 may recommend a daily budget corresponding to the average daily amount. In some implementations, the reporting engine 140 may integrate known expenses into the recommended budget. For example, the reporting engine 140 may calculate the budget based on a weekly spending amount for a location by subtracting the cost of known expenses (e.g., the cost of airfare, lodging, etc.).

In some implementations, the reporting engine 140 may transmit a recommendation 530 corresponding to an estimated budget and/or spending limit. For example, the estimated budget may include a total estimated cost of a trip based on the stored travel information and the number of attendees (e.g., as shown in FIG. 5B). In some implementations, the reporting engine 140 may automatically transmit the recommendation 530 responsive to receiving the travel parameters. In some implementations, the reporting engine 140 may transmit the recommendation 530 responsive to receiving a user input to the user interface 500 (e.g., to an estimated budget button).

The recommendation 530 may include, but is not limited to, a total estimated budget, a recommended vendor (e.g., airline, hotel, etc.), and/or spending limits. For example, as described herein, the reporting engine 140 may request alternative dates and/or locations responsive to determining one or more data elements exceeds a threshold. If the reporting engine 140 determines that alternative dates and/or locations still exceed a threshold, the reporting engine 140 may determine a spending limit (e.g., daily, weekly, by category) to maintain a budget with the above-threshold prices of lodging, transportations, etc. By way of example, the reporting engine 140 may pull data from the travel database 115 indicating a set weekly budget (e.g., over 7 days) of $1000 for a location. The reporting engine 140 may determine, based on the received travel data via the third party API, a lowest price of transportation is $500. The reporting engine 140 may determine a daily spending limit of $70 to maintain within the set budget. The reporting engine 140 may transmit a notification to the customer device 160 indicating the budget. The reporting engine 140 may cause the determined set budget to be stored within the transaction database 125 such that the reporting engine may track a user's spending relative to the budget, as described in greater detail with respect to FIGS. 4 and 7A-7D.

In some implementations, the reporting engine 140 may transmit a message to the third party system 180 responsive to a user input to the user interface 500. For example, responsive to transmitting the recommendation 530, the reporting engine 140 may receive a request to transmit a message to a merchant (e.g., a hotel company, an airline, etc.). In some implementations, the reporting engine 140 may use web scraping algorithms to extract contact information of the third party entity for transmitting the message. In some implementations, the reporting engine 140 may transmit the message via the established API link. In some implementations, the reporting engine 140 may provide a link (e.g., a URL) to a user interface 500 that allows a user to reach the third party system 180 website directly. In other words, the reporting engine 140 may allow a user of the customer device 160 to communicate with the third party system 180 directly responsive to the determined recommendation 530 (e.g., such that a user can negotiate price, book a room, etc.).

In some implementations, the reporting engine 140 may transmit a request for an increased credit line responsive to determining the one or more travel data meets the alert criteria. For example, if the reporting engine 140 determines that alternative dates and/or locations still exceed a threshold, the reporting engine 140 may transmit a request to the customer device 160 (e.g., a manager) to approve a higher budget and/or credit line for one or more users (e.g., one or more attendees of the trip). In some implementations, the reporting engine 140 may transmit a request for an adjusted spending limit (e.g., price cap) responsive to determining various prices are trending upwards (e.g., responsive to determining that a plurality of prices of lodging, transportation, and/or food are above a threshold). In some implementations, the reporting engine 140 may transmit a request for an adjusted spending limit (e.g., price cap) responsive to determining that a distance between an inputted location and a determined lodging location (e.g., hotel) exceeds a threshold (e.g., responsive to the reporting engine 140 determining a price of transportation exceeds a saving amount of lodging based on the machine learning models described herein).

In some implementations, the reporting engine 140 may determine a budget, credit line, or various other recommendations 530 based on a foreign exchange rate. For example, responsive to receiving the predetermined location for requesting the travel data, the reporting engine 140 may pull data from the travel database 115 indicating the location includes a first currency. The reporting engine 140 may compare the first currency with currency data stored in the travel database 115 to determine the first currency does or does not match at least one known currency. The reporting engine 140 may query a server of the provider computing system 110 to transmit an API call to the third party system 180 for a rate of exchange between the first currency and a second known currency. For example, the third party system 180 may be or include a foreign exchange rate database or website. In some implementations, the reporting engine 140 may use web scraping algorithms to extract the rate of exchange. The reporting engine 140 may convert the first currency into the second currency based on the extracted rate of exchange prior to, during, or after comparing the received travel data with travel information store to determine the adjusted budgets, credit lines, spending limits, projected expenses, etc.

Automating travel management and planning may have numerous advantages over conventional methods. For example, by automating the planning process by making a plurality of API calls for travel data from a singular server and cross-referencing predefined thresholds, the systems and methods herein may significantly reduce a user's click path (e.g., such that a user does not need to manually reach third party websites, rules, etc.) as compared to typical manual planning methods. Additionally, automating the process can significantly increase efficiency and effectiveness by reducing an amount of time necessary to determine an estimated budget of a trip.

Referring to FIG. 3, a flow diagram of a method 300 for managing expenses is shown, according to an example embodiment. Various operations of the method 300 may be conducted by the environment 100 and particularly parts thereof (e.g., the provider computing system 110, the customer device 160, and the third party system 180).

The reporting engine 140 receives data of an invoice at step 305. In some implementations, the reporting engine 140 may receive invoice data during an expense reporting and reimbursement process. For example, the reporting engine 140 may transmit a request to the customer device 160 for invoice data responsive to receiving a request to submit an invoice in an expense report for reimbursement.

Referring briefly to FIG. 6A, in some implementations, the reporting engine 140 may receive image data via a camera device of the customer device 160 (e.g., transmitted via the network interface 170 of the customer device 160). For example, a user of the customer device 160 can scan an invoice (e.g., a bill, a receipt, etc.) using a camera device of the customer device 160. In some implementations, the reporting engine 140 may receive the data of the invoice responsive to transmitting a prompt 610 to the customer device 160 for a user to scan an invoice (e.g., a pop-up notification, splash page on a user interface 600, etc.) for submitting an expense (e.g., responsive to the request to initiate an expense report). In some implementations, the reporting engine 140 may transmit the prompt 610 as a graphical representation rendered on a user interface 600 of the customer device 160. The graphical representation may include a selectable feature, such that the reporting engine 140 may receive a user input to the selectable feature indicating a selection to scan an invoice. Responsive to receiving the user input, the reporting engine 140 may query a camera device of the customer device 160 to scan the invoice. The reporting engine 140 may receive one or more portions of the invoice via the scan including an invoice amount 615, a date and/or time 625, an invoice location 630, at least one name 620 associated with the invoice, or various other data of the invoice.

In some implementations, the reporting engine 140 may receive invoice data via one or more manual inputs to the customer device 160. For example, the reporting engine 140 may receive an indication of a manual input to a user interface 600 of the customer device 160 selecting and/or entering various invoice data including, but not limited to, an amount 615, a date and/or time 625, a location 630, at least one name 620 associated with the invoice, or various other data of the invoice. In some implementations, the reporting engine 140 may receive invoice data via one or more uploaded documents (e.g., images, scanned images of an invoice, etc.).

Referring back to FIG. 3, the reporting engine 140 extracts data elements at step 310. In some implementations, the reporting engine 140 may extract the data elements using one or more content recognition algorithms (e.g., image correlation and recognition logic, feature extraction logic, and/or pattern recognition logic). For example, the reporting engine 140 may extract data elements by using optical character recognition (OCR), intelligent character recognition (ICR), and/or intelligent document processing (IDP) on the received image of the invoice. In other words, the reporting engine 140 may include computer-executable instructions structured to extract information from the imaged jammed document. The reporting engine 140 may use one or more artificial intelligence and machine learning models to recognize images, icons, and other features of the invoice (e.g., logos of vendors, bar codes, QR codes, etc.). The reporting engine 140 may be structured to parse out text fields from the scanned image and to determine the amount 615, date and/or time 625, the location 630, at least one name 620, or other data elements.

In some implementations, the reporting engine 140 may extract data elements from manual inputs to the customer device 160. For example, the reporting engine 140 may receive a data set from the customer device 160. The reporting engine 140 may parse the received data set and extract the amount 615, date and/or time 625, the location 630, at least one name 620, or other data elements.

The reporting engine 140 compares the data elements with stored expense information in the expense database 120 at step 315. In some implementations, the reporting engine 140 may automatically pull data from the expense database 120 responsive to receiving the invoice data. In some implementations, the reporting engine 140 may pull data from the expense database 120 responsive to a request to pull data (e.g., via a user input to the customer device 160). In some implementations, the stored expense data within the expense database 120 may include, but is not limited to, rules associated with accepted transaction amounts, authorized names, locations, transaction methods, vendors, and categories, historical data including previously known amounts, names, locations, transaction methods, vendors, and categories, and/or other expense information.

The reporting engine 140 determines if an alert criteria is met at step 320. For example, the reporting engine 140 may determine if an alert criteria is met based on the comparison between the received data elements and the stored expense information. In some implementations, the reporting engine 140 may determine an alert criteria is met responsive to determining that an invoice amount meets or exceeds a predetermined threshold amount (e.g., based on a set amount, based on a historical average, based on a threshold amount in a specific category such as food, lodging, etc.). In some implementations, the reporting engine 140 may determine that an alert criteria is met responsive to determining that a name associated with an invoice does not match any authorized names of individuals stored in the expense database 120. In some implementations, the reporting engine 140 may determine that an alert criteria is met responsive to determining that a location of the invoice does not match any authorized locations stored in the expense database 120. In some implementations, the reporting engine 140 may determine an alert criteria is met responsive to determining that a category of the invoice data is not authorized (e.g., a receipt for a liquor store in which there is a rule stored in the database 120 indicating alcoholic purchases are not authorized). For example, the reporting engine 140 may compare the vendor name, location, and/or items purchased from the invoice data with the stored expense data to determine at least one data element is not authorized. In some implementations, the reporting engine 140 may determine an alert criteria is met responsive to determining that the invoice data is duplicative (e.g., the received invoice data such as a name, location, date, and/or time matches second expense data stored in the expense database 120).

In some implementations, the reporting engine 140 may determine that an alert criteria is met responsive to determining that one or more data elements does not match previously stored data elements for a similar transaction. For example, the invoice data may include data elements of a receipt from a particular vendor. The reporting engine 140 may compare the data elements of the receipt with stored information of the vendor from a previously received invoice. The reporting engine 140 may determine that at least one element does not match (e.g., different phone number, icon, address, different spelling of a name, etc.). The reporting engine 140 may determine that the alert criteria met responsive to determining at least one element does not match (e.g., the receipt may be fraudulent or fake).

In some implementations, the reporting engine 140 may determine an alert criteria is met responsive to determining that a payment method of the received invoice data does not match any authorized payment methods. For example, the reporting engine 140 may detect an invoice was submitted to be expensed to a personal credit card instead of a corporate credit card.

In some implementations, the reporting engine 140 may use one or more geolocation matching algorithms to determine if an alert criteria is met. For example, the reporting engine 140 may determine, based on received invoice data elements, that a submitted invoice includes an address in a first location and a first name. The reporting engine 140 may be structured to pull geolocation data associated with the first location and/or first name stored in the expense database 120. For example, the reporting engine 140 may pull geolocation data of the customer device 160 associated with a name on the invoice. The reporting engine 140 may determine, by comparing the data, that at least one of the first location and/or the first name does not match a real-time geolocation. By way of example, the reporting engine 140 may receive an invoice associated with a “John Smith” from a restaurant in New York City. The reporting engine 140 may pull geolocation data of John Smith (e.g., via a mobile device location, via credit card transaction locations, etc.) and compare the data with the received invoice data. The reporting engine 140 may determine that the data does not match (e.g., John Smith is currently located in Seattle, not New York City).

In some implementations, the reporting engine 140 may use one or more machine learning models to determine if an alert criteria is met. For example, the machine learning models may be trained to identify, based on a plurality of received invoice data elements, at least one pattern of the invoice data elements (e.g., multiple invoices including the same names, the same location, etc.). The reporting engine 140 may determine, responsive to identifying the pattern, that an alert criteria is met.

If the reporting engine 140 determines an alert criteria is not met (e.g., names of individuals match authorized names, locations match authorized locations, no duplicates were determined, etc.), the reporting engine 140 may return to step 305 to receive additional invoice data.

If the reporting engine 140 determines that an alert criteria is met, the reporting engine 140 may transmit a notification 640 to a customer device 160 at step 325. For example, referring to FIGS. 6A and 6B, the reporting engine 140 may receive the invoice data from a user interface 600 of a first customer device 160 (e.g., associated with a first user profile 505, such as an employee of a corporation). The reporting engine 140 may determine an alert criteria is met and transmit a notification 640 to a user interface 650 of the first customer device 160 and/or of a second customer device 160 (e.g., associated with a second user profile 655, such as a manager of the employee). In some implementations, the notification 640 may include an indication 635 to review the submitted invoice.

In some implementations, the reporting engine 140 may additionally or alternatively store the invoice data within the expense database 120 to queue the invoice for review (e.g., by a user of the second customer device 160). For example, the reporting engine 140 may cause the provider computing system 110 to store the invoice data in the expense database 120 with an indication (e.g., unique identifier) to prevent a transfer of funds to a user account for reimbursement and/or an indication to transmit the invoice data to the second customer device 160 responsive to receiving an input to the second customer device 160 indicating a selection to review the invoice data (e.g., by receiving an input to the user interface 650). For example, the reporting engine 140 may cause a dynamic interruption in a typical expense process responsive to the reporting engine 140 determining an alert criteria has been met by transmitting the notification 640 to the user interface 650 for reviewing the invoice prior to causing initiation of a payment (e.g., refund in the amount of the invoice amount) being made to a user account associated with the user profile 505.

The notification 640 may include one or more texts, icons, images, videos, sounds, or other features that indicate to review invoice data received by the reporting engine 140. For example, as depicted in FIG. 6B, the notification 640 may include a pop-up notification including texts and/or images indicating to review an invoice. The notification 640 may include a reason for the alert (e.g., unauthorized user detected, payment amount threshold exceeded, duplicate invoice, potential fraudulent invoice, unauthorized purchase, etc.). In some implementations, the reporting engine 140 may transmit the notification 640 responsive to receiving a user input to the user interface 650 (e.g., at a coordinate of the user interface 650 corresponding to the indication 635). For example, the user input can include a manual input to the user interface 650 (e.g., a press of a finger to a touch screen, a click of a cursor, a cursor hovering over the indication 635, etc.). The indication 635 may include various images, lights, videos, sounds, or other indications flagging the submitted invoice.

Automating expense management may have many advantages over conventional techniques. For example, automating expense management by cyclically and/or continuously comparing expense information with predetermined thresholds and/or authorized purchases can increase efficiency by reducing a click path (e.g., automating the process such that a user does not need to individually open each received invoice), reducing the potential of fraud (e.g., efficiently detecting duplicates and unauthorized users, payment amounts, and/or locations), thereby increasing security, and expediting processes before a payment is initiated (e.g., alerting a user to a wrongful expense report prior to initiating a payment to a receiver).

Referring to FIG. 4, a flow diagram of a method 400 for managing transactions is shown, according to an example embodiment. Various operations of the method 400 may be conducted by the environment 100 and particularly parts thereof (e.g., the provider computing system 110, the customer device 160, and the third party system 180).

The reporting engine 140 receives transaction data of an account at step 405. In some implementations, the reporting engine 140 may receive transaction data from an account associated with the provider. For example, the reporting engine 140 may include logic that processes a transaction associated with an account holder at the provider (e.g., an account holder associated with the customer device 160). In some implementations, the reporting engine 140 may receive transaction data from a merchant or point-of-sale (POS) device (e.g., a third party system 180). For example, the reporting engine 140 may receive transaction data as a transaction request from a merchant and/or POS device including a transaction identifier, a payment identifier, a transaction amount, and a name of an account holder.

In some implementations, the reporting engine 140 may receive transaction data collected with each swipe or tap of a payment device (e.g., a credit or debit card, a mobile wallet device, a smartphone, etc.). In some implementations, the reporting engine 140 may receive transaction data by querying a server of the provider computing system 110 to request transaction data from a server of a third party system 180 via a third party API (e.g., via an API call as described herein). For example, the reporting engine 140 may request transaction data from one or more expense managing third party entities (e.g., Concur, Lyft, Uber, etc.). The transaction data may include, but is not limited to, a merchant or vendor name, a transaction amount, a date, a method of payment, a location of the transaction, a POS location, or other transaction-based information.

The reporting engine 140 compares the received transaction data with transaction information of one or more accounts stored within the transaction database 125 at step 410. In some implementations, the transaction information may include, but is not limited to, spending limits associated with a particular location, vendor, credit or debit card, dates, etc. For example, the reporting engine 140 may compare the received transaction data with a stored daily or weekly budget associated with a particular date and/or location (e.g., the determined budget described with reference to FIG. 2). In some implementations, the reporting engine 140 may compare the received transaction data with known authorized payment methods (e.g., credit or debit cards, mobile wallets, etc.) stored in the transaction database 125. In some implementations, the reporting engine 140 may compare the received transaction data with spending limits and/or authorized purchases associated with particular categories of spending (e.g., spending limits of transportation methods, lodging methods, food purchases, etc.).

The reporting engine 140 determines a remaining spending limit at step 415. For example, the reporting engine 140 may determine a remaining amount of spending left for a particular window of time (e.g., a day, a week, etc.) based on the comparison between a stored budget amount and the received transaction data. For example, the reporting engine 140 may pull a predetermined budget from the transaction database 125 (and/or from the travel database 115). The reporting engine 140 may pull the predetermined budget responsive to the reporting engine 140 receiving the transaction date (e.g., a name of the account holder, a location of a transaction, etc.) and/or responsive to receiving invoice data or travel data. For example, the reporting engine 140 may pull a predetermined budget associated with a location, a payment method, a user name, or other data elements.

The reporting engine 140 may calculate a remaining spending limit based on a total amount of the received transactions (e.g., within a period of time) and the predetermined budget. By way of example, if the predetermined budget is $100 a day and the reporting engine 140 determines a user has spent $35 already on the day, the reporting engine 140 may determine that the remaining spending limit for the day is $65.

The reporting engine 140 generates a user interface 700 at step 420. For example, the user interface 700, depicted in FIG. 7A, may include a graphical representation 730 of a remaining balance 745 for a predetermined amount of time (e.g., daily, weekly, etc.). The user interface 700 may additionally include one or more numerical indicators of a remaining balance (e.g., balance 745), a budget amount 750, and an amount spent 755 within the predetermined amount of time. The graphical representation 730 may include, but is not limited to, a container showing a spent amount 740 and a remaining amount 735. The graphical representation 730 may additionally or alternatively include one or more bar graphs, pie charts, 3D charts, line graphs, or other depictions of a remaining spending limit.

The reporting engine 140 may transmit a notification additionally and/or alternatively with the graphical representation 730. In some implementations, the reporting engine 140 may determine a ratio between the spent amount 740 and the remaining amount 740. For example, the reporting engine 140 may transmit a notification corresponding to the spent amount 740 and/or the remaining amount 735 (e.g., an alert saying “you've used 50% of your daily limit,” “you're per diem amount is $100,” etc.).

The user interface 700 may include various additional and/or alternative features. For example, the user interface 700 may include the depiction of the user profile 505. The user interface 700 may include a transaction button 710, a submitted expenses button 715, a credit information button 720, a rules button 725, and/or various other selectable features. Responsive to receiving a user input to the transactions button 710, the reporting engine 140 may generate a graphical representation 760 of previous transactions received at step 405, as depicted in FIG. 7B. The graphical representation 760 may include, for example, a report and/or listing of various expenses associated with an account of the user profile 505. The graphical representation 760 may include various transaction data received by the reporting engine 140 including, but not limited to, a date 765 of a transaction, a time 770 of a transaction, an amount 775 of a transaction, and a status 780 of a transaction. The status 780 may indicate if the transaction is normal or if the transaction is flagged. For example, the reporting engine 140 may generate a graphical representation of an alert 785 (e.g., a colored icon, a flashing light, an exclamation point, or another image, video, or sound that notifies a user of an unauthorized transaction). The reporting engine 140 may generate the graphical representation of the alert 785 responsive to the reporting engine 140 determining an alert criteria is met and/or responsive to the reporting engine 140 comparing the received transaction data with stored transaction information in the transaction database 125 (e.g., when the reporting engine 140 determines that a transaction was made using a personal credit card as opposed to an approved credit card). The reporting engine 140 may receive a user input to the graphical representation of the alert 785 indicating a user has selected the graphical representation of the alert 785. The reporting engine 140 may generate and transmit a notification to the user interface 700 responsive to receiving the user input indicating a reason for the graphical representation of the alert 785 and/or one or remedies to address the alert 785 (e.g., suggesting to use the approved credit card on the next purchase).

Responsive to receiving a user input to the submitted expenses button 715, the reporting engine 140 may generate a report of all invoices (e.g., expense reports) received by the reporting engine 140 associated with the user profile (e.g., as described with reference to FIGS. 3 and 6A). The report may including a listing of submitted invoices and invoice data including a date of an invoice, a time of an invoice, a vendor associated with the invoice, a name associated with the invoice, an approval status of the invoice for reimbursement, and/or other data.

Responsive to receiving a user input to the credit information button 720, the reporting engine 140 may generate a report that indicates a predetermined credit line (e.g., transactions limit) for one or more payment methods associated with the user account of the user profile 505. For example, the report may include predetermined credit limits based on a location, account, payment amount, category, date, time, etc. (e.g., as described with respect to FIGS. 2 and 5A-5B).

Responsive to receiving a user input to the rules button 725, the reporting engine 140 may generate a list of known rules associated with the user profile 505, location, date, time, etc. For example, the rules may include predetermined spending thresholds, authorized users, authorized vendors, authorized locations and/or methods of travel, authorized hotels, etc. (e.g., as described with respect to FIGS. 2 and 5A-5B).

The reporting engine 140 provides the generated graphical user interface 700 at step 425. For example, the reporting engine 140 may render the user interface 700 on a display of the customer device 160 responsive to generating the user interface 700.

In some implementations, the reporting engine 140 may cause the provider computing system 110 to transmit one or more API calls to a third party system 180, as described herein, to provide a recommendation of a vendor to help a user stay on track of a predetermined budget. For example, the reporting engine 140 may request price and/or location information from an exposed API of one or more applications (e.g., Yelp.com). The reporting engine 140 may determine, based on the received price information, that particular locations (e.g., vendors, retailers, etc.) include costs that are below a budget or threshold level. The reporting engine 140 may transmit a notification including the location and/or price to the customer device 160 to help a user of the customer device 160 stay within budget. In some implementations, the reporting engine 140 may cross-reference the travel database 115 for received user preferences (e.g., allergies received as a travel parameter as described herein) to determine the recommendation.

Providing the user interface 700 for tracking real-time transactions relative to a budget may have numerous advantages over conventional methods. For example, by automatically tracking transactions, the systems and methods described herein may facilitate increasing the efficiency of determining a real-time balance relative to a set limit. Further, the systems and methods described herein may facilitate increasing security by continuously and/or cyclically pulling transaction data in real-time and presenting a status 780 of the transaction data to a user interface 700.

In some implementations, the reporting engine 140 may be structured to automatically move one or more icons, images, texts, or other features of the user interface 700 responsive to determining a ratio between the budget amount 750, the amount spent 755, and/or the remaining balance 745. For example, the reporting engine 140 may continuously and/or cyclically pull and/or receive transaction data of an account associated with the customer device 160 to determine the remaining balance 745 relative to the predetermined budget amount 750. The reporting engine 140 may display the graphical representation 730 corresponding to the remaining balance 745 based on the ratio. For example, as depicted in FIGS. 7C and 7D, the reporting engine 140 may be structured to automatically update a position of the graphical representation 730 relative to various other features of the user interface 700 based on the determined ratio meeting or exceeding a threshold (e.g., stored in the transactions database 125. By way of example, the reporting engine 140 may move the graphical representation 730 to a bottom portion of the user interface 700 when the ratio is below the threshold (e.g., below 50% of the budget remaining, etc.). In some implementations, the reporting engine 140 may move another feature of the user interface 700 to a top portion of the user interface 700. For example, when the ratio is below a threshold level, the reporting engine 140 may cause the graphical representation 760 of previous transactions to be rendered above the graphical representation 730 of the budget such that a user sees the graphical representation 760 of previous transactions first on a screen of the customer device 160, as depicted in FIG. 7C.

The reporting engine 140 may automatically move the graphical representation 730 of the budget responsive to the ratio exceeding a threshold. For example, the reporting engine 140 may move the graphical representation 730 of the budget to a top or topmost portion of the user interface 700 responsive to determining the ratio between the budget and the remaining balance exceeds 50%, as depicted in FIG. 7D. The reporting engine 140 may automatically move other features of the user interface 700 below the graphical representation 730 of the budget (e.g., move the graphical representation 760 of transactions below the graphical representation 730 of the budget such that a user sees the graphical representation 730 of the budget first). In some implementations, the reporting engine 140 may transmit an alert or notification and/or render an indication of an alert 785 on the user interface 700 responsive to the ratio exceeding the threshold to flag the remaining balance to the user. The example amounts displayed in FIGS. 7C and 7D are illustrative. The amounts, ratio threshold, positioning, and/or rendering of the graphical representations may differ in various ways.

Automatically moving the graphical representations of the user interface may provide many advantages over conventional techniques. For example, typical computer systems are limited in ways to organize displayed information on a user interface. By automatically moving graphical representations of a user interface based on a predetermined threshold, the systems and methods described herein provide a specific and particular manner of automatically displaying features to a user based on relevance of the feature to a predetermined budget.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for providing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure Likewise, software and web implementations of the present disclosure may be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A computing system of a provider, comprising:
a network interface;
a database configured to store expense information of the provider; and
a processing circuit comprising one or more processors and a memory, the memory structured to store instructions that are executable to cause the one or more processors to:
receive, via the network interface and via a manual input to a first user device communicably coupled to the computing system, a request to submit an invoice for an expense reimbursement; and
query, via the network interface and responsive to receiving the request, a camera device of the first user device to scan the invoice;
receive, via the network interface and via the first user device, image data of the invoice based on the scan;
extract, via a content recognition algorithm, a plurality of data elements of the image data of the invoice;
compare the plurality of data elements with the stored expense information of the provider;
determine, based on the comparison, that at least one data element of the plurality of data elements meets an alert criteria;
store the plurality of data elements of the invoice in the database with an indication to prevent an initiation of funds corresponding to the expense reimbursement responsive to determining the at least one data element meets the alert criteria; and
transmit, via the network interface, to a second user device communicably coupled to the computing system, a notification including an indication to review the invoice.

2. The computing system of claim 1, wherein:
the at least one data element comprises a name of an individual; and
the alert criteria comprises the name of the individual not matching any names of authorized users stored in the expense information.

3. The computing system of claim 1, wherein:
the at least one data element comprises a location; and
the alert criteria comprises the location not matching any authorized locations stored in the expense information.

4. The computing system of claim 1, wherein:
the at least one data element comprises a first date and a first location; and
the alert criteria comprises the first date and the first location matching a second date and a second location stored in the expense information.

5. The computing system of claim 1, wherein:
the at least one data element comprises a payment amount; and
the alert criteria comprises the payment amount exceeding a threshold stored in the expense information.

6. The computing system of claim 1, wherein the instructions further cause the one or more processors to:
compare the plurality of data elements with the stored expense information of the provider using a machine learning model; and
determine, based on the comparison, that the at least one data element of the plurality of data elements meets the alert criteria;
wherein the machine learning model is trained to detect at least one pattern in the plurality of data elements.

7. The computing system of claim 1, wherein the instructions further cause the one or more processors to:
request, via the network interface, geolocation data of the first user device
receive, via the network interface, the geolocation data of the first user device;
compare the plurality of data elements with the stored expense information of the provider and with the geolocation data;
determine, based on the comparison, that the plurality of data elements and the geolocation data does not match; and
determine, based on the comparison, that the at least one data element of the plurality of data elements meets the alert criteria.

8. A computing system of a provider, comprising:
a network interface;
a database configured to store transaction information of a plurality of accounts of the provider; and
a processing circuit comprising one or more processors and a memory, the memory structured to store instructions that are executable to cause the one or more processors to:
receive, via the network interface, transaction data associated with an account of the plurality of accounts for a predetermined time period;
compare the transaction data with the stored transaction information of the provider;
determine, based on the comparison, a remaining spending limit of the account for the predetermined time period;
generate a graphical user interface (GUI) that includes a graphical representation corresponding to the remaining spending limit; and
provide, via the network interface and to a user device associated with the account, the GUI.

9. The computing system of claim 8, wherein the stored transaction information comprises a predetermined budget associated with the account, and the instructions further cause the one or more processors to:
determine a ratio between the remaining spending limit and the predetermined budget associated with the account;
compare the ratio with a predetermined threshold amount; and
automatically move the graphical representation corresponding to the remaining spending limit to a position on the GUI closest to a topmost portion of the GUI responsive to determining the ratio meets the predetermined threshold amount.

10. The computing system of claim 8, wherein the graphical representation includes at least one of a bar graph, a pie chart, or a 3D chart corresponding to the remaining spending limit.

11. The computing system of claim 8, wherein the graphical representation includes a numerical indicator corresponding to the remaining spending limit.

12. The computing system of claim 8, wherein the GUI includes a listing of previous transactions of the account for the predetermined time period.

13. The computing system of claim 8, wherein the instructions further cause the one or more processors to:
determine, based on the comparison, a first credit card type of the transaction data does not match a second credit card type of the stored transaction information; and
transmit, via the network interface and via the GUI, a notification indicating to use the second credit card type.

14. A computing system of a provider, comprising:
a network interface;
a database configured to store travel information of the provider; and
a processing circuit comprising one or more processors and a memory, the memory structured to store instructions that are executable to cause the one or more processors to:
request, via an application programming interface (API) of a third-party computing system and via the network interface, travel data for a predetermined date and location;
receive, via the API of the third-party computing system and via the network interface, the travel data;
compare the travel data with the stored travel information of the provider;
determine, based on the comparison, that at least one travel data element of the travel data meets an alert criteria; and
transmit, via the network interface, to a user device communicably coupled to the computing system responsive to determining the at least one travel data element meets the alert criteria, a recommendation corresponding to at least one of an alternative travel consideration, a budget, or a spending limit.

15. The computing system of claim 14, wherein the at least one travel data element of the travel data is selected from the group comprising lodging prices, lodging availability, transportation prices, transportation availability, weather data, event data, or historical location expense data.

16. The computing system of claim 14, wherein:
the at least one travel data element includes at least one of a lodging price, lodging availability, transportation price, or transportation availability;
the stored travel information of the provider includes a price threshold and an availability threshold; and
the alert criteria comprises one or more of (i) the lodging price or the transportation price exceeds the price threshold or (ii) the lodging availability or the transportation availability exceeds the availability threshold.

17. The computing system of claim 16, wherein:
the recommendation corresponds to the alternative travel consideration; and
the alternative travel consideration includes one or more of an alternative transportation method, an alternative lodging method, or an alternative date.

18. The computing system of claim 14, wherein:
the at least one travel data element includes a first currency type of the location;
the stored travel information of the provider includes a second currency type;
the alert criteria includes the first currency type being different from the second currency type; and
the recommendation corresponds to the spending limit adjusted based on an exchange from the second currency type to the first currency type.

19. The computing system of claim 14, wherein the instructions further cause the one or more processors to:
receive, via a first manual input to the user device, the predetermined date;
receive, via a second manual input to the user device, the predetermined location;
receive, via a third manual input to the user device, an amount of attendees; and
transmit the recommendation corresponding to the alternative travel consideration comprising at least one of a second date that differs from the predetermined date, a second location that differs from the predetermined location, or a second amount of attendees that differs from the received amount of attendees.

20. The computing system of claim 14, wherein the stored travel information comprises historical travel expense information, and the instructions further cause the one or more processors to:
compare the received travel data with the stored historical expense information of the provider;
determine, based on the comparison, that at least one price of the received travel data exceeds a threshold of the stored historical expense information;
determine, based on the price exceeding the threshold, that the alert criteria is met;
request, via the API of the third-party computing system and via the network interface, second travel data of a second predetermined date and location;
compare the received second travel data with the stored historical expense information of the provider;
determine, based on the comparison, that at least one price of the received second travel data exceeds the threshold of the stored historical expense information;
determine, based on the price exceeding the threshold, that the alert criteria remains met; and
transmit, via the network interface, to the user device, the recommendation corresponding to an increased spending limit responsive to determining both travel data meet the alert criteria.
